(19) United States
(12) Patent Application Publication
(10) Pub. No.: US 2016/0211562 A1
(43) Pub. Date: Jul. 21, 2016

(54) BATTERY WITH A CELL THERMAL CONTROL DEVICE AND ITS METHOD OF MANUFACTURE

(71) Applicant: SAFT, Bagnolet (FR)

(72) Inventors: Julien BOBINET, Saint Loubes (FR); Laurent POUYAU, Blanquefort (FR); Matthieu BERTIN, Villenave D'ormon (FR); Guillaume FORGET, Talence (FR)

(73) Assignee: SAFT, Bagnolet (FR)

(21) Appl. No.: 14/994,584

(22) Filed: Jan. 13, 2016

(30) Foreign Application Priority Data
Jan. 15, 2015 (FR) 15 50 330

(51) Int. Cl. H01M 10/6567; H01M 10/613

(52) U.S. Cl. CPC H01M 10/6567; H01M 10/613

(57) ABSTRACT

Electrochemical cells are mounted in a thermal control device which relies on a flow of a heat transfer fluid following round trips inside a casing thereby providing heat exchange between the heat transfer fluid and the entire wall of the electrochemical cells, and secondly, exchanges of heat which are, on average, equivalent for each electrochemical cell, regardless of its position in the thermal control device. The cells are mounted in tightly-fitting tubes arranged in the casing of the thermal control device, with their axis perpendicular to the outward and return flow directions of the heat transfer fluid inside the casing. A production process including a step of introducing the cells into the tubes is disclosed.

### BACKGROUND OF THE INVENTION

1. Field of the Invention

The invention relates to a battery that includes a device for uniformly controlling the temperature of its electrochemical cells. This device provides in particular uniform cooling of electrochemical cells in that each cell is maintained at substantially the same average temperature. The invention also relates to a method for manufacturing a battery including a step of assembling the electrochemical cells into the device.

2. Background Art

A battery is conventionally composed of one or more electrochemical cells. An electrochemical cell is generally designed to operate within a nominal temperature range. The use of an electrochemical cell outside of this temperature range may lead to limitation of its performance or premature aging. For example, charging which is conducted at too low a temperature may lead to an insufficiently charged electrochemical cell. Charging or discharge conducted at excessive temperature can lead to a rapid deterioration of battery components. Even when employed within its rated temperature range, an electrochemical cell operating at high power over a long period generates a considerable amount of heat. If this heat is not sufficiently dissipated by the ambient air, thermal runaway of the electrochemical cell or even its destruction can occur.

There is therefore a need to provide a thermal control device which makes it possible either to heat up or to cool electrochemical cells.

WO 02/07249, JP 11-054157, U.S. Pat. No. 6,228,524 and U.S. Pat. No. 5,624,003 disclose thermal control devices consisting of a rigid water jacket which comprises a rigid enclosure inside of which a heat transfer fluid circulates. This enclosure is placed in contact with the wall of the cells of the battery the temperature of which it is desired to regulate. A pump provides for circulation of the heat transfer fluid. The water jacket is generally connected to a thermostatic bath which makes it possible, depending on the case, to heat or cool the battery cells.

EP-A-1,261,065 discloses a water jacket of flexible plastics material. This flexible water jacket sleeve precisely adapts itself to the contours of the battery cells. Heat exchanges are thus favored. However, this device is difficult to implement on an industrial scale because of the long path of the water jacket around the battery cells. Secondly, those cells situated at both ends of the cooling device can have different temperatures as a result of the heating up (or cooling down) of the heat transfer fluid resulting from its passage in contact with the electrochemical cells. This temperature difference is more marked when the battery has a large number of cells. In addition, this type of device makes it difficult to maintain the temperature of electrochemical cells below 55° C. using a heat transfer fluid temperature at the inlet of 25° C. Heat exchange between the heat transfer fluid and the electrochemical cells additionally only takes place at no more than 20% of the side surface thereof.

There is therefore a real need for a thermal control device which solves the problems mentioned above and in particular a device which provides for:
heating or cooling of the entire wall of the battery cells, in order to obtain a high level of heat exchange,
equivalent heating or cooling of each electrochemical cell regardless of its position in the device so that the electrochemical cells undergo aging which is as homogeneous as possible.

### SUMMARY OF THE INVENTION

To this end, the invention provides a battery in which the electrochemical cells are mounted in a thermal control device which relies on a flow of the heat transfer fluid which follows round trips thereby, firstly, providing heat exchange between the heat transfer fluid and the entire wall of the electrochemical cells of the battery, and secondly, exchanges of heat which are, on average, equivalent for each electrochemical cell of the battery, regardless of its position in the device.

More specifically, the invention provides a battery comprising a thermal control device for electrochemical cells,

the device comprising a fluid-tight casing comprising a plurality of tubes arranged substantially parallel to each other, each of the ends of the tubes emerging outside of the casing, n partitions, in which n≧1, extending transversely to the direction defined by the longitudinal axis of the tubes so as to compartmentalize a space surrounding the plurality of tubes within the casing into n+1 volumes, the device being provided with communication means for establishing communication between two contiguous volumes separated by a partition, the communication means associated with a given partition being disposed distally with respect to communication means associated with adjacent partitions, the device also having inlet means for entry of a heat transfer fluid into a volume defined by a first partition, and outlet means for discharging said fluid outside of a volume defined by a last partition, the communication means of a first and last partition of the series of partitions being disposed distally respectively with respect to the inlet means and with respect to the outlet means for the heat transfer fluid,

with electrochemical cells being housed inside the tubes of the thermal control device, said electrochemical cells being electrically insulated with respect to said tubes.

Optional, supplementary or alternative features of the invention are given below.

The tubes can be distributed in at least one row comprising at least two tubes.

The means for establishing communication between two contiguous volumes can be comprised of one or more openings in a partition and/or of one or more conduits arranged outside the casing.

The tube cross-section can be circular, elliptical or rectangular.

The casing and the tubes of the device can be made of steel or aluminum.

The casing and the tubes of the device can be made of elastomer or plastics material, said elastomer or plastics material comprising fillers.

The inner surface of the tubes can be treated all or in part in order to be non-conductive electrically and/or highly conductive thermally and/or so as to have a coating which reduces its coefficient of friction.

Certain ones of the plurality of tubes of the thermal control device can be adapted for the passage of means for securing said device onto a support.

Each electrochemical cell can have a lateral surface, a bottom and a cover, at least 75% of said lateral surface being in contact with the casing, preferably at least 90%, even more preferably 100%.

The invention provides a method of manufacturing a battery, comprising a step of mounting the electrochemical cells into the tubes of the thermal control device, said step including the step of expanding the tubes.

Optional, supplementary or alternative features of the method are given below.

The expansion of the tubes can be performed by heating the device, said device being of steel or of aluminum.

The expansion of the tubes can be performed by evacuating air from spaces inside of said casing, said device being of elastomer or of plastics material.

### BRIEF DESCRIPTION OF THE DRAWINGS

FIG. 1 is a diagrammatic view of electrochemical cells assembled in a thermal control device according to the invention.

FIG. 2 is a diagrammatic view of a thermal control device according to the invention.

FIG. 3 is an exploded view of a thermal control device according to the invention.

FIG. 4 shows the variation of temperature of the electrochemical cells of a battery, used during successive cycles of charge-discharge. These cells are cooled by a thermal control device of the prior art.

FIG. 5 shows the variation of temperature of the electrochemical cells of a battery, used during successive cycles of charge-discharge. These cells are cooled by a thermal control device according to the invention.

FIG. 6 is a diagrammatic view showing the principle of the invention.

### DETAILED DESCRIPTION OF PREFERRED EMBODIMENTS

The thermal control device in which the electrochemical cells are mounted will now be described with reference to FIGS. 2, 3 and 6.

The device comprises a fluid-tight casing 1. The term fluid-tight when used herein means that the casing is adapted to contain fluid without risk of leakage. This sealing characteristic is obtained through a suitable choice of the materials constituting the casing and the accompanying manufacturing process.

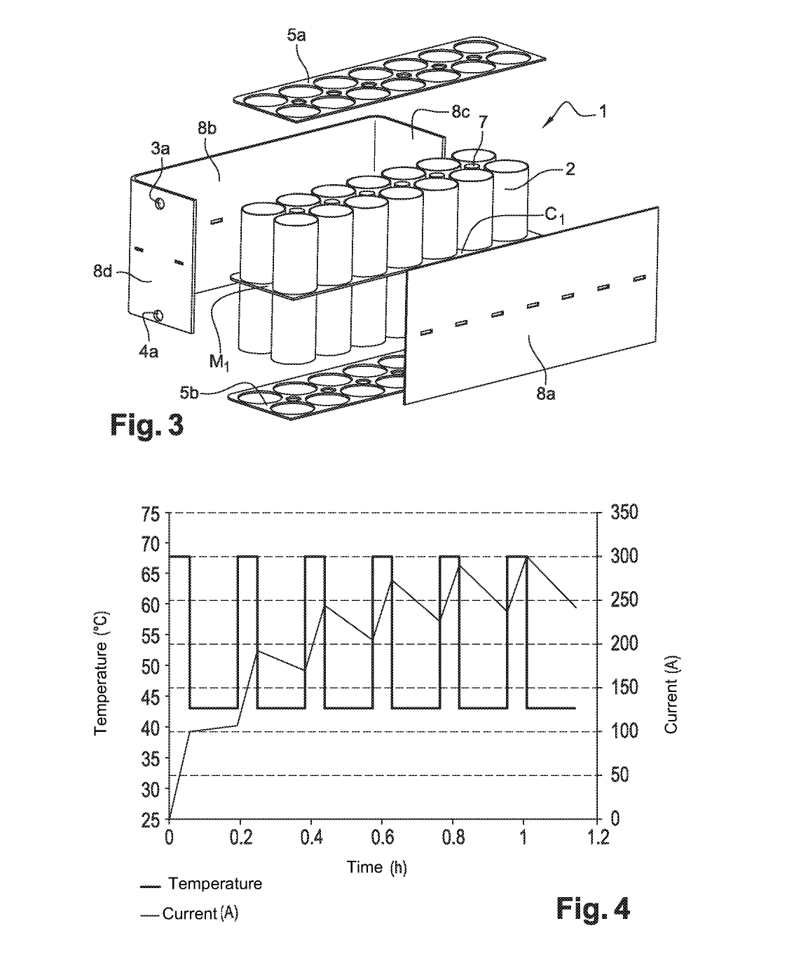

The casing encloses a first plurality of tubes 2, fourteen in the present case, disposed in a substantially mutually parallel manner. Each end of each tube opens to the outside of the casing 1 and defines in its interior a chamber 2a for accommodating the electrochemical cells. Obviously, to avoid short circuits, the electrochemical cells are electrically insulated vis-a-vis the tubes. The tubes are of circular cross-section in the embodiment shown in FIGS. 2 and 3 and are adapted to regulate the temperature of cylindrical electrochemical cells. They can also have a square or elliptical cross-section in the case where the electrochemical cells the temperature of which is to be controlled are prismatic or even oblong in shape. In order to preserve a certain compactness of the device, the tubes are preferably arranged inside the casing in mutually parallel rows, the device comprising at least one row of at least two tubes, namely in the example described two rows of seven tubes.

In order to optimize compactness of the device, the tubes may be arranged in staggered rows.

The casing has a generally parallelepiped shape, two of the six faces being traversed by the plurality of tubes and the remaining four faces bearing the references 8a to 8d.

As provided for in the embodiment shown in FIGS. 2 and 3, the space surrounding the fourteen tubes is compartmentalized in accordance with a first volume V1 and a second volume V2 by means of a partition C1 which extends transversely to the direction defined by the longitudinal axis of the tubes.

Of course, it is possible to envisage other embodiments of the invention in which the space surrounding a plurality of p tubes inside the casing 1 may be compartmentalized by means of a series of n partitions referenced Ck, k varying between 1 and n. These partitions are substantially parallel to each other, and consequently extend transversely to the direction defined by the longitudinal axis of the tubes so as to divide said space into n+1 volumes Vk.

As provided for in the embodiment shown in FIGS. 2 and 3, the partition C1 has communication means M1 between volume V1 and volume V2, which thus allows a heat transfer medium to flow from volume V1 to volume V2. As shown in FIG. 2, these communication means M1 comprise a conduit which extends outside of the casing but which is connected at both ends to wall 8d, said ends communicating at one end with volume V1 and at the other end with volume V2.

As shown in FIG. 3, the communication means M1 consist of an opening formed in the partition C1. Of course, these communication means can assume multiple and varied configurations.

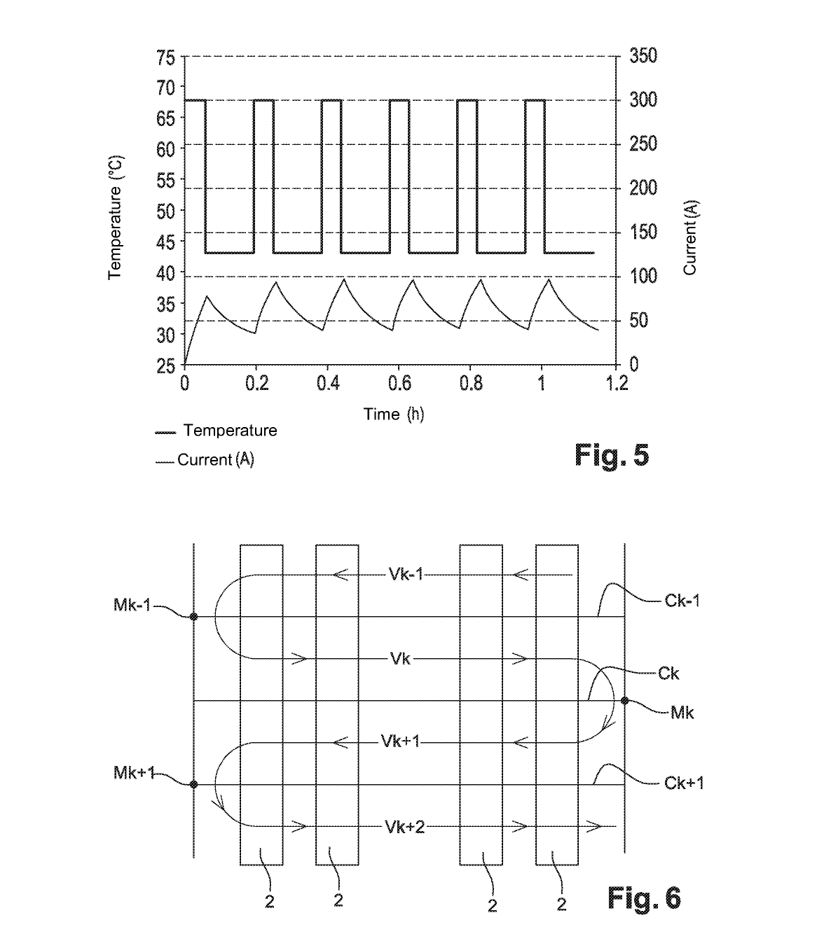

Referring to FIG. 6 which concerns an embodiment in which the space surrounding a plurality of p tubes inside the casing 1 is partitioned into a series of n partitions referenced Ck, where k is from 1 to n and n≧1, it is necessary to provide means Mk for establishing communication Mk between each volume Vk and each volume Vk+1 each separated by a partition Ck. Of course, these communication means Mk can be one or several openings in the partition Ck or consist of one or more conduits connecting a volume Vk to a volume Vk+1, this or these conduits being able to extend within and outside of the casing.

So that the heat transfer fluid is able to traverse the entire extent of the space Vk, the communication means Mk are disposed distally relative to the communication means Mk−1 of the preceding partition. Indeed, heat transfer fluid arrives from space Vk−1 to enter space Vk via the communication means Mk−1 and enters the space Vk+1 via the communication means Mk. Also, by spacing the communication means Mk and Mk−1 as far apart as possible, the heat transfer fluid is obliged to flow throughout the entire extent of the space Vk. To ensure that the heat transfer fluid also passes through the whole extent of the space Vk+1, the communication means Mk are disposed distally relative to the communication means Mk+1 of the next partition. The characteristic of being “disposed distally”, should be taken to mean that the communication means Mk and Mk+1 are arranged to be as distant as possible from each other. More specifically, the communication means Mk are formed near one of the walls of the casing or on the actual wall itself, while the communication means Mk+1 and Mk−1 are formed close to the opposite wall.

As provided for in the embodiment shown in FIGS. 2 and 3, the device includes means 4 for admitting heat transfer fluid into the volume V1, and means 3 for discharging said fluid out of the volume V2. Communication means M1 are disposed distally relative to the inlet means 4 and to the outlet means 3 for the heat transfer fluid. The characteristic of being “distally disposed” refers to the fact that the communication means M1 are arranged to be as far as possible from inlet means 4 and from the outlet means 3. More specifically, the communication means M1 are formed close to the wall 8c of the casing in the case where they consist of an opening, or on the wall itself in the case where they consist of a conduit, while the inlet means 4 and outlet means 3 are arranged on the opposite wall 8d.

Preferably, positioning of the inlet means 4, of the outlet means 3 and of communication means M1 is chosen so that the fluid travels along a path in the length direction rather than in the width direction of the partition C1.

Referring to FIG. 6 which concerns an embodiment in which the space surrounding a plurality of p tubes inside the casing 1 is partitioned in accordance with a number of partitions n, the device also includes the means 4 for admitting heat transfer fluid into the volume V1 defined by the first partition of the series, and means 3 for discharging said fluid to outside the volume Vn defined by the last partition in the series. Communication means M1 of the first partition of the set are then arranged distally relative to the inlet means 4, the communication means Mn of the last partition of the series being also disposed distally with respect to the outlet means 3 for the heat transfer fluid. Here, the characteristic of being “distally disposed” refers to the fact that the communication means M1 and Mn are arranged so as to be respectively as far as possible from inlet means 4 and outlet means 3. More precisely, the communication means M1 and Mn are respectively formed near the wall of the casing opposite to the wall close to which the inlet means 4 and the outlet means 3 are arranged.

Thus, in the case where there is an even number n of partitions, the heat transfer fluid performs n−1 round trips plus one outward journey. In contrast, in the case where there is an odd number n of partitions, the heat transfer fluid performs n round trips.

Preferably, the positioning of the inlet means 4, of the outlet means 3 and of the communication means Mk is chosen so that the fluid travels along the path generally in the length direction rather than in the width direction of the partition Ck.

Advantageously, the device includes a second plurality of tubes 7 which provide a passage for means for securing said device to a support. The securing means can be tie rods.

The casing and the tubes can be of steel or aluminum. In this case, the method of manufacturing the control device implements manufacturing steps that are known to those skilled in the art and involving in particular providing the tubes and six plates, two of the latter carrying bores appropriate to the diameter of the tubes. The assembly of the plates enclosing the tubes positioned opposite the bores in the plates being preferably carried out by welding.

The casing and the tubes may also be made of elastomer or even plastics material, these materials preferably including fillers to improve their mechanical properties. The manufacturing process will then comprise at least one molding step.

Depending on the chosen material, and advantageously, the inner surface of the tubes 2 can be entirely or partially treated so as to be non-conductive as regards electricity but highly conductive as regards heat, or so as to have a coating for reducing their coefficient of friction.

The coatings giving the inner surface of the tubes electrically insulating properties are preferably conformal coatings of silicone or are based on ethylene-propylene-diene monomers.

The coatings which give the inner surface of the tubes a thermally-conductive character are preferably based on silicone gel along with certain resins.

The coatings giving the inner surface of the tubes a lubricating character are preferably solid lubricants such as graphite, zinc oxide, boron nitride, molybdenum disulfide, graphite fluoride, tin sulfides, bismuth sulfides, or tungsten disulfide, calcium fluoride, certain thiosulfates, polytetrafluoroethylene or certain polyamides.

Turning now to the optimal use of the thermal control device, it is essential that the diameter of the tubes 2 is the best possible fit to the electrochemical cells. This provides in effect a more pronounced contact between the side surface of the electrochemical cell and the inner surface of the tubes, and consequently a greater degree of heat exchange. Therefore, the invention also provides a method for mounting electrochemical cells into a thermal control device as described above.

In order to be able to easily insert the electrochemical cells into the enclosures 2a of the device, it is advisable to proceed with a step leading to the expansion of the tubes 2.

Where the device is made of steel or aluminum, expansion of the tubes 2 is achieved by heating of the device.

In the case where the device is made of elastomer, expansion of the tubes 2 is achieved by evacuating air from the interior spaces Vk inside the casing at a pressure for example less than atmospheric pressure.

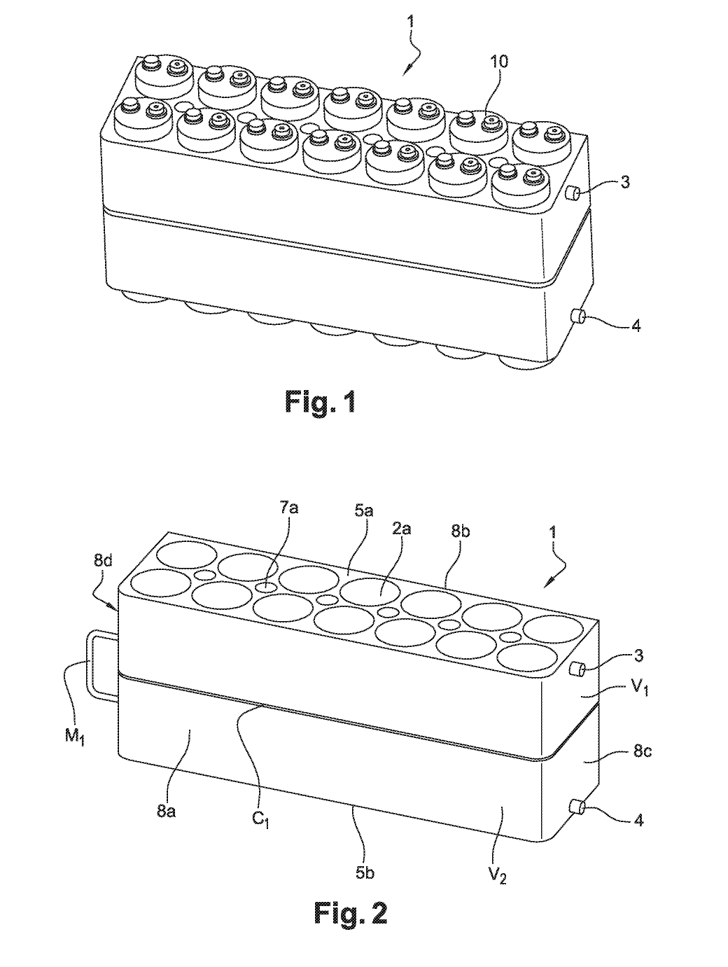

Once inserted into the device and as shown in FIG. 1, each electrochemical cell having a side surface, a bottom and a lid, is in contact through at least 75% of its side surface with the casing.

Regarding the type of heat transfer fluids, it is possible to use any kind and in particular demineralized water which is particularly effective in terms of heat exchange, mixtures of demineralized water and ethylene glycol, mineral oils, dielectric fluids of the perfluorocarbon type.

Comprehensive thermal and fluid dynamics simulations were performed in order to validate the invention when compared to existing solutions and more particularly with respect to solutions implementing thermal control devices which comprise a rigid water jacket which comprises a rigid casing in which a heat transfer fluid circulates. The heat transfer fluid was a 50/50 water/glycol mixture set to a regulated temperature of 20° C. at a flow rate of 3 L/min. The power P being dissipated by each electrochemical cell under steady state conditions was 38 W.

| Type of device | Description | |
|---|---|---|
| Rigid water | Solution using rigid polypropylene | Existing |
| jacket | passing between two rows of cells. | solution |
| | Contact over 20% of the side surface. | |
| Flexible water | Solution using soft polyurethane | Existing |
| jacket | passing and expanding between the | solution |
| | two rows of cells. Contact over 20% | |
| | of the side surface. | |
| Device of elastomer | According to the invention | Invention |
| material | | |
| Device of metal | According to the invention | Invention |
| Device of plastics | According to the invention | Invention |
| material | | |

The results obtained enabled it to be shown that the cooling of the electrochemical cells was homogeneous (less than 2° C. difference between each electrochemical cell), and that the drop in pressure head was low (less than 234 Pa).

The results obtained also enabled a high level of thermal performance of the device according to the invention to be demonstrated since the thermal exchange coefficient H is between 30 W/m²K and 100 W/m²K.

The following table summarizes the thermal performance of existing solutions and some embodiments of the invention:

| | Thermal performance | |
|---|---|---|
| Type of device | H Coefficient (W/m² · K) | |
| Rigid water | 16.2 | Existing |
| jacket | | solution |
| Flexible water | 22.8 | Existing |
| jacket | | solution |
| Device of elastomer | 100 | Invention |
| material | | |
| Device of metal | 40 < H < 100 (depending | Invention |
| | on optimization) | |
| Device of plastics | 30 < H < 100 (depending | Invention |
| material | on optimization) | |

FIG. 4 shows that the existing solutions of the “water jacket” type do not prevent temperature rise for an exchange coefficient with the electrochemical cells H equal to 22.8 W/m²·K.

FIG. 5 shows, in contrast, that the solutions according to the invention make it possible to contain the rise in temperature with a thermal exchange coefficient H which can reach 100 W/m²·K, in other words more than four times that of existing solutions of the “water jacket” type.

The invention consequently allows the electrochemical cells to be kept at a temperature below 40° C. for high power applications.

This thermal control device exhibits above all a maximized capacity to cool/warm up insofar as the heat transfer fluid is around the entire side surface of the electrochemical cells. This solution additionally makes it possible to ensure thermal homogeneity exists over the totality of the electrochemical cells due to the round-trip hydraulic architecture. Indeed, in the course of its path of travel, the heat transfer fluid defines a temperature gradient in all of the spaces Vk it passes through, while reversing the direction of temperature gradient each time it passes through a partition. The result is that the sum of the heat exchanges in the direction defined by the longitudinal axis of the tube is constant at each tube, and consequently at each electrochemical cell. The latter are consequently subject to an identical degree of cooling/warming up.

This thermal control device has other non-negligible advantages, insofar as it makes it possible to de-correlate the heat transfer fluid from the electrochemical cells, the heat transfer fluid no longer being in contact with the wall of the electrochemical cell. The sealing and electrical insulation characteristics of the device make it possible not only to broaden the possibilities of choosing the heat transfer fluid but also to integrate the device into an open structure.

Because of its simplicity of form, the mounting of the electrochemical cells into the thermal control device can be automated as can the integration of the module made up by the assembly consisting of the thermal control device and the electrochemical cells into a production line for electrochemical cells.

As a result of the fact that the heat transfer fluid circulates in spaces having a significant cross-section, loss of pressure head through the device are minimized, and it is possible to use low heat transfer fluid flow rates.

1. A battery comprising a thermal control device for electrochemical cells, the thermal control device comprising a fluid-tight casing comprising:
a plurality of tubes arranged substantially parallel to each other, each of the ends of the tubes emerging outside of the casing,
n partitions Ck, in which n≧1 and 1≦k≦n, extending transversely to the direction defined by the longitudinal axis of the tubes so as to compartmentalize a space surrounding the plurality of tubes within the casing into n+1 volumes V,
the device being provided with communication means Mk for establishing communication between a volume Vk and a volume Vk+1, said volumes being separated by a partition Ck,
in which communication means Mk are disposed distally with respect to communication means Mk−1 for establishing communication between a volume Vk−1 and the volume Vk separated by a partition Ck−1, and distally with respect to communication means Mk+1 for providing communication between a volume Vk+1 and a volume Vk+2 separated by the partition Ck+1,
said device also having inlet means for entry of a heat transfer fluid into the volume V1 defined by the first partition, and outlet means for discharging said fluid outside of the volume Vn+1 defined by a last partition,
the communication means M1 and Mn of a first and last partition of the series of partitions being disposed distally respectively with respect to the inlet means and with respect to the outlet means for the heat transfer fluid,
the battery further comprising electrochemical cells housed inside the tubes of the thermal control device, said electrochemical cells being electrically insulated with respect to said tubes.

2. The battery of claim 1, wherein the tubes are distributed in at least one row comprising at least two tubes.

3. The battery according to claim 1, wherein the means Mk for establishing communication between a volume Vk and a volume Vk+1 are comprised of one or more openings in a partition Ck.

4. The battery according to claim 1, wherein the means Mk for establishing communication between a volume Vk and a volume Vk+1 a volume are comprised of one or more conduits arranged outside the casing.

5. The battery according to claim 1, wherein the means Mk for establishing communication between a volume Vk and a volume Vk+1 are comprised of one or more openings in a partition Ck as well as one or more conduits arranged outside the casing.

6. The battery according to claim 1, wherein the tube cross-section is circular or rectangular.

7. The battery according to claim 1, wherein the casing and the tubes of the device are made of steel or aluminum.

8. The battery according to claim 1, wherein the casing and the tubes of the device are made of elastomer or plastics material.

9. The battery according to claim 1, wherein the inner surface of the tubes is treated all or in part in order to be non-conductive electrically and/or highly conductive thermally and/or so as to have a coating which reduces its coefficient of friction.

10. The battery according to claim 1, wherein certain ones of said plurality of tubes are adapted for the passage of means for securing said device onto a support.

11. The battery according to claim 1, wherein each electrochemical cell has a lateral surface, a bottom and a cover, at least 75% of said lateral surface being in contact with the casing.

12. A method of manufacturing a battery comprising a thermal control device for electrochemical cells,
the thermal control device comprising a fluid-tight casing comprising:
a plurality of tubes arranged substantially parallel to each other, each of the ends of the tubes emerging outside of the casing,
n partitions Ck, in which n≧1 and 1≦k≦n, extending transversely to the direction defined by the longitudinal axis of the tubes so as to compartmentalize a space surrounding the plurality of tubes within the casing into n+1 volumes V,
the device being provided with communication means Mk for establishing communication between a volume Vk and a volume Vk+1, said volumes being separated by a partition Ck,
in which communication means Mk are disposed distally with respect to communication means Mk−1 for establishing communication between a volume Vk−1 and the volume Vk separated by a partition Ck−1, and distally with respect to communication means Mk+1 for providing communication between a volume Vk+1 and a volume Vk+2 separated by the partition Ck+1,
said device also having inlet means for entry of a heat transfer fluid into the volume V1 defined by the first partition, and outlet means for discharging said fluid outside of the volume Vn+1 defined by a last partition,
the communication means M1 and Mn of a first and last partition of the series of partitions being disposed distally respectively with respect to the inlet means and with respect to the outlet means for the heat transfer fluid,
the battery further comprising electrochemical cells housed inside the tubes of the thermal control device, said electrochemical cells being electrically insulated with respect to said tubes,
wherein the method comprises at least a step of mounting the electrochemical cells into the tubes of the thermal control device, said step including the step of expanding the tubes.

13. The method of manufacturing a battery according to claim 12, wherein the expansion of the tubes is performed by heating said device, and in particular said tubes, said device being of steel or of aluminum.

14. The method of manufacturing a battery according to claim 12, wherein the expansion of the tubes is performed by evacuating air from spaces inside of said casing, said device being of elastomer material.

15. The battery according to claim 8, wherein said elastomer or plastics material comprises fillers.

16. The battery according to claim 11, wherein each electrochemical cell has a lateral surface, a bottom and a cover, at least 90% of said lateral surface being in contact with the casing.

17. The battery according to claim 11, wherein each electrochemical cell has a lateral surface, a bottom and a cover, at least 100% of said lateral surface being in contact with the casing.

18. The method according to claim 12, wherein certain ones of said plurality of tubes are adapted for the passage of means for securing said device onto a support.

19. The method according to claim 12, wherein each electrochemical cell has a lateral surface, a bottom and a cover, at least 75% of said lateral surface being in contact with the casing.

20. The method according to claim 12, wherein the inner surface of the tubes is treated all or in part in order to be non-conductive electrically and/or highly conductive thermally and/or so as to have a coating which reduces its coefficient of friction.
